(19) United States
(12) Patent Application Publication
(10) Pub. No.: US 2019/0176154 A1
(43) Pub. Date: Jun. 13, 2019

(54) VESSEL COMPRISING A SENSOR DEVICE AND COMMUNICATION MEANS

(71) Applicant: Merck Patent GmbH, Darmstadt (DE)

(72) Inventors: Brian DANIELS, Seeheim-Jugenheim (DE); James KUGLER, St. Louis, MO (US); Owen LOZMAN, Southampton (GB); Wiebke DONDRAS, Buettelborn (DE); Toby CULL, Romsey (GB); Mark JAMES, Romsey (GB); Gerald MUELLER, Gross-Zimmern (DE)

(73) Assignee: Merck Patent GmbH, Darmstadt (DE)

(21) Appl. No.: 16/307,600

(22) PCT Filed: Jun. 2, 2017
(86) PCT No.: PCT/EP2017/063432

§ 371 Date: Dec. 6, 2018

Related U.S. Application Data
(60) Provisional application No. 62/346,084, filed on Jun. 6, 2016.

(51) Int. Cl. B01L 3/00; G06Q 10/08

(52) U.S. Cl. CPC B01L 3/545; B01L 3/52; G06Q 10/087; B01L 2300/0663; B01L 2300/022; B01L 2300/023; B01L 2300/024; B01L 2200/16

(57) ABSTRACT

The present invention relates to a vessel comprising a device, said device being a sensor or an information storage device or both, and a communication means to transfer data from said vessel to a receiver. The present application also relates to a system, for example a storage system, comprising such vessel.

### TECHNICAL FIELD

The present invention relates to a vessel comprising a device, said device being a sensor or an information storage device or both, and a communication means to transfer data from said vessel to a receiver. The present application also relates to a system, for example a storage system, comprising such vessel.

### BACKGROUND AND DESCRIPTION OF THE PRIOR ART

Environmental and safety aspects play an ever larger role in any laboratory; including for example synthetic and analytical laboratories that use chemicals, as well as in chemical plants. Laboratories and chemical plants are therefore required to provide detailed and up-to-date information on the stored chemicals, which is of particular importance in case of an accident, such as a fire or an explosion. Additionally, in order to minimize the consequences of any accident and also for environmental reasons the amount of chemicals stored in a laboratory or chemical plant is to be kept to a minimum. This will generally also require good inventory management with regards to the amount of chemicals in storage as well as with regards to inventorying all types of chemicals present in a laboratory or chemical plant.

At the same time customers request ever shorter delivery and lead times, which necessitates sufficient stocks of chemicals to be able to quickly meet changing demands.

These conflicting requirements are a great challenge for laboratories and chemical plants and can only be met by stringent stock control and demand planning.

However, the present methods of stock control and demand planning still lead to situations where crucial chemicals may not be on hand in sufficient amount, thereby leading, for example, to longer delivery times and/or monetary losses.

It is therefore an object of the present application to provide a system that will be able to improve stock control and/or demand planning, preferably automatically.

It is a further object of the present application to provide a system that allows for reduced environmental and safety risks.

Additionally, it is an object of the present application to provide a vessel, which may be used for storing goods or bulk goods, such as for example chemicals, comprising a means for storing and providing information on the contents of such vessel.

### SUMMARY OF THE INVENTION

The present inventors have now surprisingly found that the above objects may be attained either individually or in any combination by the vessel and the system of the present application.

The present application therefore provides for a vessel comprising a device and a communication means for transferring data between said vessel and a receiver, preferably from said vessel to a receiver, wherein said device is a sensor or an information storage device or both.

The present application therefore also provides for a system comprising such vessel.

### DETAILED DESCRIPTION OF THE INVENTION

For the purposes of the present application, the term “bulk goods” is used to denote goods that are not packaged individually (for example, not packaged in single use portions), also referred to as “loose goods”.

The present application relates to a vessel comprising a device and a communication means for transferring data between said vessel and a receiver, preferably from said vessel to a receiver.

Said vessel is not particularly limited. It may be any vessel suitable for storing bulk goods, such as for example liquids, solids, gases, solutions, dispersions, colloids (e.g. emulsions, foams, suspensions, sols, aerosols, gels, biofluids), powders, particles, granules, pellets, pills and any mixture of any of these.

An exemplary vessel may, without limitation, be selected from the group consisting of bottle, box, silo, dispenser, intermediate bulk container (IBC), tank, drum and container.

Said vessel may be made of any material that is generally used to store bulk goods, particularly chemicals. Examples of such materials may be selected from—but are not limited to—the group consisting of plastics, glass, ceramics, metal and any combination of any of these. Exemplary polymers may be selected from—but are not limited to—polypropylene (PP), polyethylenes, such as high density poly-ethylene (HDPE) or low density polyethylene (LDPE) or linear low density polyethylene (LLDPE), fluoropolymers, such as polytetrafluoroethylene (PTFE, “Teflon”), polyethylene terephthalate (PET), and polybutylene terephthalate (PBT). It is noted that the skilled person is well aware of which materials may best be suited for specific bulk goods and may select the material accordingly.

Said vessel is not particularly limited with regards to volume. Preferably, the vessel has a volume of at least 1 ml, for example of at least 2 ml, 3 ml, 4 ml, 5 ml, 10 ml or 20 ml or 30 ml or 40 ml or 50 ml or 60 ml or 70 ml or 80 ml or 90 ml or 100 ml or 150 ml or 200 ml or 250 ml or 300 ml or 350 ml or 400 ml or 450 ml or 500 ml. Preferably, the vessel has a volume of at most 100 m³, for example of at most 50 m³ or 40 m³ or 30 m³ or 20 m³ or 10 m³ or 5 m³ or 4 m³ or 3 m³ or 2 m³ or 1 m³ or 500 l or 400 l or 300 l or 200 l or 100 l or 90 l or 80 l or 70 l or 60 l or 50 l or 40 l or 30 l or 20 l or 10 l or 9 l or 8 l or 7 l or 6 l or 5 l or 4 l or 3 l or 2 l or 1 l.

The device comprised in said vessel comprises a sensor or an information storage device or both. Preferably said device is a sensor or an information storage device or both.

The location of said device on or in said vessel (e.g. the location at which it is mounted on said vessel) is of no particular importance. Said device may, for example, be mounted on the outside of said vessel or on the inside of said vessel or be integrated into the housing or casing of said vessel. The location of said device on or in said vessel may be suitably selected by the skilled person so as to be well adapted to the intended use. Said device may, for example, also be mounted in a cavity of said vessel, said cavity preferably being designed to hold said device. It is noted that the components of said device, for example the sensors, and the communication means need not be placed together. For example, a number of sensors may be placed at different spots on the outside or the inside of the vessel or any other suitable position. It is also possible that the communication means are placed together with one or more sensors while further sensors are placed elsewhere in the vessel.

It is noted that the present device may also be a separate unit (i.e. not comprised on or in a vessel), for example, before being applied onto or into a vessel. Such a separate unit may then be attached to the vessel, for example before the vessel is to be used, by any suitable attachment means. If the present device is a separate unit (i.e. not comprised on or in a vessel) it preferably comprises suitable attachment means as defined herein. Or alternatively, such separate device may be supplied in form of a label, sticker or similar.

Suitable attachment means for attaching said device to a vessel are not particularly limited and may be selected according to what is most suitable for the respective vessel and device. Non-limiting examples of suitable attachments means may be selected from the group consisting of adhesives (glues), one-sided or two-sided adhesive tapes, clips, Velcro, straps, latches, snaps, string, threaded components (e.g. screws), and any combination of any of these. Alternatively, the device may, for example, be comprised in a sleeve, pocket, casing or housing attached to or comprised in or on said vessel. Said attachment means may, for example, be of the same material or may be of a different material as said vessel. In case of attachment means selected from the group consisting of clips, latches, snaps, threaded components, sleeve, pocket, casing or housing it may be preferable that the attachment means and the vessel are essentially of the same material.

The sensor is not particularly limited. Preferably it may be any sensor or any combination of sensors suitable to detect one or more (i.e. at least one; for example one, two, three, four, five, six, seven, eight, nine or ten) of the properties selected, for example, from the group consisting of weight, mass, filling level, pressure, density, brightness, temperature, location, humidity, movement (motion), orientation, acceleration, capacitance, electromagnetism, radiation, electrical conductivity and thermal conductivity. Thus, the sensor may be one or more selected from the group consisting of weight sensor, mass sensor, filling level sensor, pressure sensor, density sensor, brightness sensor, temperature sensor, location sensor, humidity sensor, movement (motion) sensor, orientation sensor, acceleration sensor, capacitive (capacitance) sensor, electromagnetic sensor, radiation sensor, electrical conductivity sensor and thermal conductivity sensor. Another example is a sensor for detecting opening and closing of any closure means comprised in or on said vessel, optionally also recording the respective data and time of such opening and closing, or for recording the time at which any closure means comprised in or on said vessel is opened for the first time, or capable of both, i.e. for detecting opening and closing of any closure means comprised in or on said vessel, optionally also recording the respective data and time of such opening and closing, and also for recording the time at which any closure means comprised in or on said vessel is opened for the first time. Of these, a sensor or any combination of sensors suitable for detecting filling level, location, movement (motion) and opening and closing of any closure means comprised in or on said vessel are more preferred.

Preferably, the present device comprises one or more (i.e. at least one) sensors (for example, two three, four, five, six, seven, eight, nine or ten) sensors.

Preferably said sensor is suitable to determine the filling level of or in said vessel. For example, such filling level sensor may, independently of any other sensor optionally present and of each other if more than one filling level sensor is present, be selected from the group consisting of pressure sensor, weight sensor, level sensor, volume sensor, capacitance sensor, capacitive sensor, mass sensor, strain gauge sensor, ultrasonic sensor, optical sensor and any combination of any of these. Preferred examples of such sensor may independently of each other be selected from the group consisting of pressure sensor, weight sensor, capacitance sensor, capacitive sensor, strain gauge sensor, ultrasonic sensor, optical sensor and any combination of any of these. If such sensor is mounted on the inside of said vessel, said sensor is preferably selected from the group consisting of capacitance sensor, capacitive sensor, optical sensor and any combination of any of these. These types of sensors are generally well known to the skilled person and may, for example, be obtained from commercial sources.

A suitable example of a filling level sensor is a load cell. In such a load cell, a strain gauge is mechanically (e.g. through a mechanical arrangement) deformed by the force (e.g. the force exerted by a weight) to be sensed. Such deformation will then result in a change in electrical resistance, which is a measure of the strain and consequently of the applied force. A load cell may preferably comprise one or more strain gauges, for example two, three or four strain gauges. Most preferably the load cell comprises four strain gauges in a Wheatstone bridge configuration. For practical use, the electrical output of a strain gauge or of a load cell is preferably amplified.

Another example of a filling level sensor is a load cell, wherein the electrical output or signal is generated by a piezoelectric material, with the electrical output being proportional to the deformation, thus allowing the determination of the force (and consequently the weight) acting upon the load cell.

A further example of a suitable filling level sensor is a capacitive sensor or capacitance sensor. A capacitive sensor works on the basis of changes in the electrical capacity of a single capacitor or of a capacitor system. Generally a capacitive sensor comprises two electrodes forming the capacitor. When a material such as a dielectric material or an electrically conducting material is brought into proximity of the electrodes the measured capacity changes, thereby allowing the filling level in a vessel to be determined.

Load cells comprising one or more strain gauges or load cells comprising a piezoelectric material may also be used as weight sensor, mass sensor or pressure sensor.

Suitable pressure sensors may, for example, be selected from the group consisting of the strain gauge type as described above, capacitive type, electromagnetic type, piezoelectric type, potentiometric type and optical type, of which the strain gauge type and the piezoelectric type are preferred.

Suitable humidity sensors (“hygrometers”) may, for example, be selected from the group consisting of the capacitive type, the resistive type, and the thermal type. In a capacitive humidity sensor the effect of humidity on the dielectric constant of a polymer or a metal oxide is measured and correlated with relative humidity. In a resistive humidity sensor the change in electrical resistance of a material, for example a salt or an electrically conductive polymer, due to humidity is measured. As the output of a resistive humidity sensor also depends on temperature, it is preferably combined with a temperature sensor. In a thermal humidity sensor the change in thermal conductivity of air caused by humidity is determined.

Suitable acceleration sensors (“accelerometers”) and motion sensors may, for example, be selected from the group consisting of piezoelectric accelerometers, micro-electro-mechanic accelerometers and gyroscopes. Micro-electro-mechanic accelerometers generally comprise a cantilever beam with a so-called proof mass. External accelerations will result in the proof mass being deflected from its original position. This deflection may be measured in analog or digital manner. A preferred method for determining the deflection is by measuring capacitance between a fixed reference and the deflected proof mass. A gyroscope may also be used as accelerometer. Generally, a suitable gyroscope has a weight on one of its axes, said weight then reacting to the force generated by acceleration, from which the acceleration and the velocity may be calculated.

Data collected by a filling level sensor may, for example, also help in determining unintended loss of contents from a vessel, such as for example in case of the vessel leaking or being broken. In such case the data may further be used to initiate an automated shutdown of any installation that may potentially be affected.

Data collected by a temperature sensor may, for example, be used to identify situations of the temperature of the vessel going outside of temperatures, at which safe storage or use of the contents of the vessel is no longer ensured, and can consequently be remedied.

Data collected by a humidity sensor in combination with data collected by a sensor determining the opening and closing of any closure comprised on the vessel may help in tracking and re-calculating the shelf-life or expiry date of moisture-sensitive compounds. If materials sensitive to moisture are opened multiple times in a humid atmosphere then this may cause faster degradation than in a vessel opened only occasionally in a dry atmosphere. In this example the humidity can be recorded by the device together with the number of vessel closure open events. This data is then sent to the system and the user can be notified of a shorter expiry date.

Where a means of detecting the opening and closing of any closure on the vessel is provided this can be used to identify the first opening of the vessel and the exposure of the material within to the atmosphere. For regulatory reasons the logging of the date of first opening is often recorded, and in this instance the timestamp can be logged, stored and transmitted to the system for further processing. Knowledge of this opening event also enables the user to track the time since the vessel seal has been broken and hence by when the contents should be consumed.

Any opening and closing event of the vessel can also be logged by the device and transmitted to the system as a means of predicting or determining when the contents will potentially be depleted, and therefore modifying the state of the device.

Preferably, the one or more sensors comprised in the device may store their respective readings (e.g. of temperature, pressure, humidity) together with a timestamp, i.e. with the date and time when the respective reading was taken.

Said device comprising said sensor may, for example, be integrated into one selected from the group consisting of label, sleeve, sheet, film, laminate, a molded enclosure or casing or housing (for example, a molded plastic enclosure, casing or housing), any additional enclosure and screen and/or may be integrated into wall, bottom or base of the vessel.

The data collected by the one or more sensors comprised in the device of said vessel may—depending upon the intended use of the vessel—be stored and processed in an internal data storage and processing system, or be stored in an internal data storage system and subsequently be transferred to and processed in an external data processing system, or be directly upon collection transferred to an external data storage and processing system. It is noted that any data transferred between the vessel and any external data storage and/or processing system may be encrypted to prevent unauthorized access thereto. For reasons of clarity it is also noted that the external data storage may also be a or in a data cloud environment, in which case the vessel preferably directly sends data to the data cloud environment. The data cloud environment may then serve, for example, as data storage until the data is accessed for processing.

Thus, preferably said vessel comprises or is connected to an electronic device, which in the following will be referred to as “electronic device” so as to distinguish it from the device comprised in the vessel, capable of performing analysis of the data obtained by the one or more sensors comprised in the device of said vessel.

In case the data collected by the one or more sensor comprised in the device is to be stored for a certain time (e.g. 1 minute, 1 hour, 1 day, 1 month or 1 year or any other period of time) and processed in the vessel in an internal data processing system, the vessel preferably comprises means for storing data and an electronic device capable of performing analysis on the data obtained from said one or more sensor. Following analysis, the processed data or the data obtained from the one or more sensor or both may be transmitted to an external data processing system for further storage or processing or both.

In case the data collected by the one or more sensor comprised in the vessel is to be stored in an internal data storage system first and then processed in an external data processing system, the vessel preferably comprises both, means for storing data and communication means for transmitting said data to an external data processing system.

In case the data collected by the one or more sensor comprised in the vessel is to be directly upon collection transmitted to an external data processing system, the vessel preferably comprises communication means for transmitting said data to the external data processing system.

For the purposes of the present application the term “external data processing system” is used to denote an external, i.e. not directly comprised in the sensor device or permanently connected to the sensor by physical means, system for data storage or data processing system or both.

The information storage device is not particularly limited and may be any device capable of storing information. Said information storage device may be the same as or different from the internal data storage means used to store data collected by the one or more sensors. Preferably, said information storage device is any integrated circuit (e.g. System-on-a-Chip, memory chip, RFID (“radio frequency identification”) chip), tag or label.

Preferably the information stored on said information storage device includes an identification of the goods inside the vessel, such as an identification number or a descriptive name. Optionally, further information, such as for example information on any one or more of physical properties, chemical properties, certificates of analysis (CoA), dangers, handling instructions, incompatibilities with other chemicals, production-related or goods-related information may be included on said information storage device. Such further information may, for example, prove essential to emergency response personnel in case of an accident or fire or any other state of emergency. Any such information on the contents of the vessel may be transmitted for documentation to a laboratory management system in a validated environment or an electronic laboratory journal in R&D laboratories.

In case only an identification of the goods inside the vessel is stored on said information storage device, the vessel is preferably connected or equipped to be able to connect to an external information storage device, where further information, such as, for example, information on any one or more of physical properties, chemical properties, dangers, handling instructions, incompatibilities with other chemicals is stored.

For transferring data between said vessel and one or more receivers, preferably from said vessel to one or more receivers, the vessel comprises a communication means.

Said communication means is not particularly limited and may suitably be selected by the skilled person from commercially available communication means so as to best fit the specific vessel and the intended application. Preferably said communication means is a communication means for transferring a signal to an external receiver. Such communication means may, for example, be one or more of wires or cables, or wireless transmission, or a combination of both. Wireless transmission is preferred.

Exemplary wireless communication means may without limitation be selected from the group consisting of Bluetooth connector (including, but not limited to Bluetooth Low Energy or Bluetooth Smart), LoRa connector, sub-GHz network connector (for example, SigFox, LoRa, LoRaWAN, ZigBee) wireless (WiFi) connector, NFC (near-field communication) connector, RFID chip, antenna, hardware connections and cabling, and any combination of these. Preferably said communication means is selected from the group consisting of Bluetooth connector, wireless connector, sub-GHz network connector, NFC (near-field communication) connector, RFID chip and any combination of any of these. Most preferably, said wireless communication means is a Bluetooth connector or a sub-GHz network connector, for example SigFox, LoRa, LoRaWAN, ZigBee, and any combination of these. Without wishing to be bound by theory it is believed that a sub-GHz network, such as SigFox, LoRa, LoRaWAN and ZigBee, is best suited to transmit communications across longer distances, through storage cabinets and/or in crowded network environments.

Depending upon the respective needs and application said vessel may also comprise more than one (for example two, three, four, five or even six) different communication means.

In one aspect, the communication means is used to activate and change the communication state of the device via software. One example is the activation of communication radios once the vessel has reached its usage destination therefore conserving power. Another example is the use of RFID chip and a tag, reader or writer to transfer a signal and change the state of the device. To further conserve power a magnetically activated switch can be incorporated, such that the RFID functionality is not activated until in the presence of a suitable magnetic field. Without wishing to be bound by theory It is believed that such functionality is advantageous not only for the preservation of power, but it will also allow a device to be shipped via land sea or air with its radios disabled and then allow these to be wirelessly re-enabled once the vessel has reached its destination.

Further, said communication means may also be used as location sensor or part of a location sensor, rather than the vessel comprising a separate specific location sensor. Said communication means are preferably used, either in isolation or in combination with a communication system, to determine the location of the vessel. Such determination of location may work, for example, globally (e.g. during shipping) or locally (e.g. during storage).

Also, RFID chips, stickers or tags, either active or passive, may be used to determine the location of a vessel within a defined area or space, such as a factory site, a storage site, a building, a part of a building, one or more than one rooms (e.g. one or more than one laboratories) by data exchange between the vessel comprising such a RFID chip, sticker or tag, and a system as defined in the following. For example, passive RFID chips, stickers or tags may be placed at various locations throughout the area or space, in which the location of the vessel is to be determined. Such RFID chip, sticker or tag may be permanently or non-permanently placed onto or integrated into walls, doors, storage cabinets, fixed instruments, workspaces, shelves or any other type of furniture.

In another example a stationary powered RFID reader may be used to activate and receive the unique identifier (“ID”) from a RFID chip, sticker or tag and in turn transmit this to the system. As the location of the reader is known to the system this allows the presence of the vessel comprising such RFID chip, sticker or tag to be recorded and tracked at such location.

Alternatively, said communication means may also be used to be in communication with other components of a communication network to collect the vessel's identifier (“ID”), the respective signal strength, and use this to determine the relative position of this vessel by triangulation, e.g. by determining the location of the vessel making use of the signal strengths, directions etc. of communications means with known location.

Furthermore, it is possible to use the so-called beacon technology for localizing the vessels in a defined space or area. In this technology hardware transmitters, so-called Bluetooth beacons, based on Bluetooth Low Energy (BLE) devices are used to transmit their identifier to any nearby vessel of the present application that is adapted to receive such identifier. Using the signal of one, preferably of more than one such beacon the device comprised in the present vessel or any processing system is capable of determining the location of this specific vessel.

It is believed that such method for determining the location of a vessel in combination with the identifier (“ID”) of the respective vessel will allow warning of potential incompatibilities in storage conditions and reduce potentially dangerous events in manufacturing site or laboratory. Furthermore, such methods will allow for locating “lost” vessels, i.e. vessels that are not at their intended location. Also, another benefit is that the location of vessels used on specific laboratory equipment can be determined and recorded, enabling automated tracking of vessel consumption. Furthermore, knowing the location of a vessel with a non-normal status as determined by the system enables the user to quickly identify and remedy such a state.

The data obtained by one or more sensors may also be used to alter the mode of operation of the device and communication means comprised in the vessel. For example, motion detected by a motion sensor (such as an accelerator or a gyroscope) may serve as initiator and activate or, alternatively, turn off other sensors and communication means, and/or change the frequency of measurements or data transmittal. Thus, the data gathered by one or more sensors is used to change the operational state of the device and communication means comprised by the vessel.

Alternatively, it may also be possible to use a magnetically activated switch to initiator and activate or, alternatively, turn off other sensors and communication means, and/or change the frequency of measurements or data transmittal, when the presence of a suitable magnetic field is detected. Alternatively, the vessel can be activated by manually switching the vessel into its working mode, for example, using a manual switch that needs to be physically switched or by manual activation using an interface, e.g. a software interface on a computer, a smart phone. Thus, the present vessel may further comprise an optional magnetically or manually activated switch.

Preferably, said vessel also comprises a device supplying electricity, e.g. for supplying any electricity required for the function of the sensor(s) and the communication means. More preferably, said vessel comprises a device storing electricity or a device converting light into electricity. The types of devices storing electricity or devices capable of converting light or motion into electricity are not very limited and can be selected depending upon the specific needs and uses of said vessel.

An example of a device storing electricity is a battery. A preferred battery is a printed battery.

Another example of a device capable of storing electricity is a capacitor or super capacitor.

An example of a device capable of converting light into electricity is a photovoltaic cell (frequently also referred to as “solar cell”). A preferred photovoltaic cell is an organic photovoltaic cell. For the purposes of the present application, the term “organic photovoltaic cell” is used to denote a photovoltaic cell, wherein at least one layer, preferably the photoactive layer, comprises an organic compound in more than 50 wt %, relative to the total weight of the composition of which said layer consists.

Preferably said vessel may also comprise a display, such as an electronic display. Such display may, for example, show information stored on said information storage device and/or data collected by the one or more sensors. For example, the display may show information on the filling level of the vessel and/or an indication on whether a new order to replenish the vessel needs to be placed.

In one aspect, the display may be a light emitting device, including a light emitting diode (LED), an organic light emitting display (OLED) or an electrochromic display. Such display can be used to indicate to any user or potential user, for example, the state and condition of the vessel using, for example, flashing sequences, colors or a combination of flashing sequences and colors. Exemplary and non-limiting states may include “OK”, “vessel empty”, “vessel error”, “vessel communication active”, “vessel in transit”, “re-supply ordered”, the last one optionally in combination with the expected delivery date. The light emitting device may also be activated by an external signal sent to the vessel in order to enable the user or potential user to visually locate the vessel in the laboratory or plant.

In another aspect, the display may include, for example, information on the contents of the vessel, information on their safe handling and hazard data of the contents of the vessel or branding information (e.g. the name of the supplier and/or the supplier's logo). The information on the display can be updated using external input (for example from the system via any communication device present on the vessel) or internal input (for example from the one or more sensors and/or a timer comprised in the device). The advantages of such a display can be seen in more easily allowing to re-label such vessels to accommodate, for example, the need to use different branding names in different markets or countries, updated regulatory information, and the displaying of the information in a language adapted to the respective location of such vessel.

Preferably said vessel further comprises an electronic device (that is not an electronic display) that is connected to said device or directly to said one or more sensors.

Preferably said electronic device is selected from the group consisting of printed circuit board, flexible printed circuit board. organic electronic device or an electronic device comprising organic and inorganic materials.

Preferably, said electronic device is capable of performing analysis of the data obtained from said sensor or combination of one or more sensors. Said electronic device is capable of sending a signal when one or more value obtained from the one of more sensors comprised in the device is outside a predetermined range.

For example, when said sensor is a filling level sensor, said electronic device is capable of sending a signal when the filling level inside the vessel falls below a pre-determined value. Said signal may preferably be sent to a display or to an automated ordering system or to an inventory management system or to any combination or even all of these. Said display may be an internal display, i.e. the display comprised by the vessel, or an external display; an order for replenishing the goods in the vessel may subsequently be placed manually. In case of an automated ordering system such order is placed by the ordering system with minimal or even without any manual intervention.

Some goods require well defined storage conditions, such as well-defined temperature or humidity conditions. For example, when said sensor is a temperature sensor, said electronic device is capable of sending a signal when the temperature inside the vessel or outside the vessel goes outside a pre-determined range, which may, for example, be the preferred temperature range for storing the goods inside the vessel.

Preferably, the device has a set of variables controlling the frequency of sensor sampling, the power status of sensors and communication connectors and frequency and content of data sent wirelessly to the system. As the vessel enters various points in its lifecycle the device is able to detect these changes and modify these variables accordingly to enter different ‘use states’.

Preferably, in the case when said sensor is a accelerometer or gyroscope, said electronic device will use this input to modify the use state of the device, for example determining that the vessel is in use and activating other sensors such as a filling level sensor and activating communications to the system.

The information stored in the information storage device comprised in or on said vessel can be transmitted to an external data processing unit (for example a smartphone, a personal computer or a lab information system). Said data processing unit can then, for example, issue an alert in case a vessel not containing the intended goods is to be used.

Furthermore the information stored in the information storage device comprised in or on said vessel can be transmitted to emergency response teams and/or rescue workers and/or firefighters in case of an accident or fire. This will help emergency response teams and/or rescue workers and/or firefighter to adapt their responses, thereby reducing the risk of error.

The present application is also directed to a system comprising said vessel.

Said system may preferably be selected from the group consisting of storage system, transport system, supply system, laboratory or plant management system, waste disposal system and any combination thereof.

Preferably such system comprises means for placing one or more vessels as defined above. Exemplary means for placing one or more vessels may preferably be selected from the group consisting of shelf, cupboard, cabinet, carrier, rack, pallet, box (e.g. shipping box) and crate. The selection of such means for placing one or more vessels may depend upon the intended use. For example, in case of a storage system said means for placing one or more vessels may preferably be selected from the group consisting of carrier, pallet and crate. For example, in case of a laboratory management system said means for placing one or more vessels may preferably be selected from the group consisting of cupboard, cabinet and shelf.

Preferably said system further comprises a means for computing signals or data received from said one or more vessels. Such means for computing signals or data may be considered as “external data processing system” in respect to the vessel as such. This external data processing system may, for example, compute signals or data received from one or more vessels comprising a sensor for determining filling level, thereby determining the filling level or the inventory level.

In case the vessel comprises a sensor to determine the vessel's filling level, said system preferably comprises means, for example the “external data processing system” in respect to the vessel as such, to determine projected consumption of the goods comprised in said vessel.

In case of a waste disposal system the present system further comprises a trash bin or a waste removal system comprising one or more receivers, which receive signals from any of the vessels of the present application deposited therein. The system can then, for example, detect the product that was to be disposed of, remove this from the inventory list, and optionally place an order or—if such order is normally placed in a different manner—verify if such order has been placed. Furthermore such system can, for example, verify that the respective vessel is placed in the disposal channel suitable for the goods comprised in said vessel, thereby potentially leading to a further reduction of environmental risks.

Preferably, the present system has the ability of defining the state of any individual vessel registered with it. For example, it is able to distinguish between a full vessel, a full vessel in storage, an opened vessel, a vessel the contents of which are being consumed, a vessel nearly empty and in need of replenishment, a vessel that has been disposed of. These states may be changed through calculation by the system, or by the registering of a physical state change by the device attached to the vessel and communicated to the system such as a change in mass or volume, the triggering of an event by a sensor for example a cap or closure opening event, or the communications of a signal received by the device to the system, for example the transfer of an RFID identity.

Based on the data gathered by the system from the various sensors and particularly in respect to the relative location of the vessels in combination with information on the contents of said vessels (e.g. whether the contents are hazardous) the system may—if programmed in such a way—be used to trigger an alarm notifying of incorrect storage and/or use conditions.

It is believed that the vessel and the system disclosed in the present application will greatly help improving safety and reducing environmental risks in laboratories using chemicals and chemical plants by allowing for direct integration of information and data coming from each individual vessel into a system, for example a plant or laboratory management system, thereby allowing on the one hand to reduce inventory levels and on the other hand side allowing for more accurate planning of the amount of goods needed.

Furthermore, the vessel and the system disclosed in the present application will reduce the risks of accidents by being able to warn of potential errors ahead of them occurring, i.e. by warning that a wrong chemical is to be added to a chemical reaction. In addition this will lead to a reduction in waste due to human error and thereby avoid or reduce monetary losses.

### EXAMPLE

The following example is intended to illustrate the advantages of the present vessel and the corresponding system in a non-limiting way.

For testing the vessel and system of the present application, a limited number of glass bottles were equipped with a filling level sensor of the strain gauge type as well as with LoRa and Bluetooth Smart and/or Bluetooth Low Energy (BLE) communication means. The filling level sensor was attached to the bottom of the bottle, while the communication means as well as other electronic components were comprised in a label that was attached to the side of the bottles. The glass bottles were then filled with a hydrocarbon solvent. An industrial analytical laboratory having a constant consumption of such solvent was equipped with a gateway and a data storage and processing system to collect the data generated by and transmitted from said vessels.

The solvent bottles, the gateway and the data storage and processing system were then tested under real-life conditions for a total of six weeks and were found to perform surprisingly well. It was found that significant savings in working time could be realized due to it no longer being necessary to manually control the filling levels for each vessel at regular intervals. Very surprisingly, it was also found that the work flow in the analytical laboratory could be improved because of the reduction of shortages in solvent supplies and consequently in the reduction in last-minute orders for solvents.

1. Vessel comprising a device and a communication means for transferring data between said vessel and a receiver, preferably from said vessel to a receiver, wherein said device is a sensor or an information storage device or both.

2. Vessel according to claim 1, wherein said vessel is a vessel for storing liquids, solids, gases, solutions, dispersions, colloids, powders, particles, pills and any mixture of any of these.

3. Vessel according to claim 1, wherein the sensor is one or more selected from the group consisting of weight sensor, mass sensor, filling level sensor, pressure sensor, density sensor, brightness sensor, temperature sensor, location sensor, humidity sensor, movement sensor, orientation sensor, acceleration sensor, capacitive sensor, electromagnetic sensor, radiation sensor, electrical conductivity sensor and thermal conductivity sensor.

4. Vessel according to claim 1, wherein said device comprises a sensor for determining the filling level or the mass or both of said vessel.

5. Vessel according to claim 4, wherein said sensor is selected from the group consisting of pressure sensor, weight sensor, level sensor, volume sensor, capacitance sensor, capacitive sensor, mass sensor, strain gauge sensor, ultrasonic sensor, optical sensor and any combination of any of these.

6. Vessel according to claim 5, wherein said sensor is selected from the group consisting of pressure sensor, weight sensor, capacitance sensor, capacitive sensor, strain gauge sensor, optical sensor and any combination of any of these.

7. Vessel according to claim 1, wherein said device is mounted on the outside of said vessel.

8. Vessel according to claim 1, wherein said device is mounted on the inside of said vessel.

9. Vessel according to claim 1, wherein said device is integrated into one or more selected from the group consisting of a label, a sleeve, additional enclosure, or into the walls or the bottom or any closure means of said vessel.

10. Vessel according to claim 1, wherein said communication means is preferably selected from the group consisting of Bluetooth connector, LoRa connector, sub-GHz network connector (SigFox, LoRa, LoRaWAN, ZigBee), wireless (WiFi) connector, NFC (near-field communication) connector, RFID chip, hardware connections and cabling, and any combination thereof, and is preferably selected from the group consisting of Bluetooth connector, sub-GHz network connector, wireless connector, NFC (near-field communication) connector, and any combination thereof.

11. Vessel according to claim 1, further comprising a sensor capable of determining opening and closing of any closure means comprised in or on said vessel, or capable of recording the time at which any closure means comprised in or on said vessel is opened for the first time, or capable of both.

12. Vessel according to claim 1, further comprising at least one display or a light emitting device.

13. Vessel according to claim 1, further comprising a device capable of storing electricity or of converting light into electricity, wherein such device preferably is a photovoltaic device, a capacitor or a battery, more preferably an organic photovoltaic device or a printed battery.

14. Vessel according to claim 1, further comprising an electronic device connected to said sensor.

15. Vessel according to claim 14, wherein said electronic device is selected from the group consisting of printed circuit board, flexible printed circuit board, organic electronic device or an electronic device comprising organic and inorganic materials.

16. Vessel according to claim 14, wherein said electronic device is capable of performing analysis of the data obtained from said sensor.

17. Vessel according to claim 14, wherein said electronic device is capable of sending a signal when one or more value obtained from the one or more sensors comprised in the device is outside a predetermined range.

18. Vessel according to claim 14, wherein said electronic device is capable of sending a signal when the filing level falls below a pre-determined value.

19. Vessel according to claim 17, wherein said signal is sent to a display or to an automatic ordering system.

20. System comprising one or more than one vessel of claim 1.

21. System according to claim 20, wherein said system is selected from the group consisting of storage system, transport system, supply system, laboratory management system, waste disposal system and any combination thereof.

22. System according to claim 20, further comprising a means for computing signals or data received from said one or more vessels.

23. System according to claim 20, wherein said system comprises a means to determine projected consumption.

24. System according to claim 20, further comprising a means for computing signals or data received from said one or more vessels, thereby determining a filing level or inventory level.

25. System according to claim 22, wherein said means is capable of sending a signal when the filing level or the inventory level falls below a pre-determined value, or is expected to fall below a pre-determined value within a pre-determined time period.

26. System according to claim 24, wherein said signal is sent to a display, or to an automatic ordering system.

27. System according to claim 21 wherein said system comprises means for placing one or more vessels of said system.
